(19) United States
(12) Patent Application Publication
(10) Pub. No.: US 2022/0304303 A1
(43) Pub. Date: Sep. 29, 2022

(54) INSECT REPELLENT PATCHES

(71) Applicant: The Natural Patch Company Pty Ltd, Prahran (AU)

(72) Inventors: Michael Isaac Jankie, Prahran (AU); Gary Paul Tramer, Prahran (AU)

(21) Appl. No.: 17/702,465

(22) Filed: Mar. 23, 2022

Related U.S. Application Data
(60) Provisional application No. 63/165,463, filed on Mar. 24, 2021.

(51) Int. Cl. A01N 25/34; A01N 25/24; A01N 65/44; A01P 17/00

(52) U.S. Cl. CPC A01N 25/34; A01N 25/24; A01N 65/44; A01P 17/00

(57) ABSTRACT

The present disclosure generally relates to a wearable insect repellent patch and sheets of such patches. Each patch consists of a patch substrate and an adhesive layer on the patch substrate, wherein the adhesive layer is configured to allow the wearable patch to be removably attached to a wearer or an object associated with the wearer or another human, wherein the patch substrate comprises an active agent. The active agent is an insect repellent that is configured to release an effective amount of the insect repellent for repelling insects or masking the wearer or the object associated with the wearer or another human from insect detection. The insect repellent consists of one or more essential oils. The present disclosure also relates to kits and packages comprising insect repellent patches.

### RELATED APPLICATIONS

This application claims priority to U.S. Provisional Patent Application No. 63/165,463, filed on Mar. 24, 2021, the entire contents of which are incorporated herein by reference.

### FIELD

The present disclosure generally relates to wearable insect repellent patches. The present disclosure also relates to wearable insect repellent patches consisting of a patch substrate and an adhesive layer on the patch substrate and to products and packages including such patches. The present disclosure also relates to a process for preparing the wearable insect repellent patches and to use of the wearable insect repellent patches to repel insects or mask a wearer from insect detection.

### BACKGROUND

Diethyltoluamide, also known as DEET, is the most common active ingredient in insect repellents. It is a slightly yellow oil intended to be applied to the skin or to clothing and provides protection against mosquitoes, ticks, fleas, chiggers, leeches and many biting insects. Recent studies suggest that DEET functions as a contact repellent.

DEET is a synthetic compound and as a precaution, should not be used under clothing or on damaged skin, and preparations should be washed off after they are no longer needed or between applications.

A correlation between the concentration of DEET and hours of protection against insect bites has been identified, such that 100% DEET was found to offer up to 12 hours of protection while several lower concentration DEET formulations (20-30%) offered 3 to 6 hours of protection.

When used as directed, products containing between 10% and 30% DEET have been found to be safe to use on children, as well as adults, but it is recommended that DEET not be used on infants less than two months old. However, there remains controversy as to the toxicity of synthetic insect repellents, especially when applied as a topical lotion or sprayed directly onto the skin.

Therefore, there is a need for alternative or improved wearable insect repellent products that are natural, safe, and can repel insects or mask a wearer from insect detection.

### SUMMARY

The present disclosure provides a wearable insect repellent patch comprising an all-natural insect repellent. The wearable patch consists of a patch substrate and an adhesive layer on the patch substrate. The patches can be used for repelling insects or masking a wearer or an object associated with the wearer or another human from insect detection when removably attached to a wearer or an object associated with the wearer or another human, e.g. on the wearer's clothing or skin.

One aspect relates to a wearable insect repellent patch consisting of a patch substrate and an adhesive layer on the patch substrate, wherein the adhesive layer is configured to allow the wearable patch to be removably attached to a wearer or an object associated with the wearer or another human, wherein the patch substrate consists of an active agent, wherein the active agent is an insect repellent that is configured to release an effective amount of the insect repellent for repelling insects and/or masking the wearer or the object associated with the wearer or another human from insect detection, and wherein the insect repellent consists of one or more essential oils.

In an embodiment, the patch substrate may include a woven fabric. The patch substrate may include a non-woven fabric.

In an embodiment, the adhesive layer may be selected from solvent based adhesives, water based adhesives, acrylic pressure sensitive adhesives, resin emulsion adhesives, silicone based adhesives, and hot-melt adhesives.

The thickness of the patch substrate may be in the range of between about 0.1 mm to about 3.0 mm. The specific gravity of the insect repellent in the patch substrate may be between about 1% to about 30% by weight of the patch substrate.

In some embodiments, the insect may be a mosquito. The wearer may be a human or non-human animal. For example, the wearer may be a human.

In some embodiments, the patch may be configured to release an effective amount of the insect repellent over a period of time of up to 72 hours to repel insects and/or mask the wearer from insect detection.

Another aspect relates to a product, such as a sheet, comprising one or more wearable insect repellent patches according to any embodiment described herein, wherein the patches are located on one side of a carrier sheet, and wherein the one or more patches are configured to be peeled away from the carrier sheet for application of one or more patches to a wearer.

Another aspect relates to a wearable insect repellent patch consisting of a patch substrate and an adhesive layer on the patch substrate, wherein the adhesive layer is configured to allow the wearable patch to be removably attached to a wearer or an object associated with the wearer or another human, wherein the patch substrate consists of an active agent and optionally one or more excipients, wherein the active agent consists of an insect repellent that is configured to release an effective amount of the insect repellent for repelling insects and/or masking the wearer or the object associated with the wearer or another human from insect detection, and wherein the insect repellent consists of one or more essential oils.

Another aspect relates to an insect repellent kit, the kit comprising: i) a sealed or sealable package; ii) at least one carrier sheet in the package, the at least one carrier sheet comprising a plurality of wearable patches configured to be peeled away from the carrier sheet, each wearable patch consisting of a patch substrate and an adhesive layer on the patch substrate, wherein the adhesive layer is configured to allow the wearable patch to be removably attached to a wearer or an object associated with the wearer or another human, wherein the patch substrate comprises an insect repellent that is configured to release an effective amount of the insect repellent for repelling insects or masking the wearer or the object associated with the wearer or another human from insect detection, and wherein the insect repellent comprises one or more essential oils; and iii) optionally a printed instruction configured to facilitate use of the wearable patch on the wearer or the object associated with the wearer or another human.

In an embodiment, the package may comprise between about 1 and 50 of the carrier sheets, such as 2, 3, 4, 5 or more sheets up to about 50. The thickness of the package may be in a range of between about 1 mm to about 50 mm, for example. The width of the package may be in a range of between about 5 cm to about 15 cm, for example. The length of the package may be in a range of between about 10 cm to about 25 cm, for example.

Another aspect relates to a method for repelling insects or masking a human or non-human animal from insect detection. The method may comprise the steps of: i) providing a wearable insect repellent patch consisting of a patch substrate and an adhesive layer on the patch substrate, wherein the adhesive layer is configured to allow the wearable patch to be removably attached to a wearer, wherein the patch substrate comprises an insect repellent that is configured to release an effective amount of the insect repellent for repelling insects or masking the wearer from insect detection, and wherein the insect repellent comprises one or more essential oils; ii) removing one or more patches from a carrier sheet for application onto the wearer or an object or garment associated with the wearer or another human; and iii) applying one or more wearable patches to the wearer or the object or garment associated with the wearer or another human for up to 72 hours to repel insects and/or mask the wearer from insect detection.

In an embodiment, the process may further comprise saturating the patch substrate with an amount of the insect repellent after step i) but before step iii).

### BRIEF DESCRIPTION OF THE DRAWINGS

Embodiments of the present disclosure will be further described and illustrated, by way of example only, with reference to the accompanying drawings in which:

FIG. 1 is a perspective view of a carrier sheet comprising 6 insect repellent patches according to some embodiments.

FIG. 2 is a side cross-sectional view of an insect repellent patch as described herein having an adhesive layer configured to allow the patch to be removed or peeled away from a carrier sheet for application onto a piece of clothing of a wearer;

FIG. 3 is a plan view of a carrier sheet comprising 4 insect repellent patches according to some embodiments;

FIG. 4 is a plan view of a carrier sheet comprising 8 insect repellent patches according to some embodiments; and

FIG. 5 is a side sectional view of a package containing multiple ones of the carrier sheets according to some embodiments.

### DETAILED DESCRIPTION

The present disclosure describes the following various non-limiting examples, which relate to investigations undertaken to identify alternative and improved wearable insect repellent patches, and to any use thereof.

### General Definitions and Terms

In the following description, reference is made to the accompanying drawings which form a part hereof, and in which are shown, by way of illustration, various embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the disclosure. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of” or “one or more of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination in other embodiments.

Throughout the present specification, various aspects and components of the disclosure can be presented in a range format. The range format is included for convenience and should not be interpreted as an inflexible limitation on the scope of the disclosure. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” or “consisting of” is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

As used herein, the term about, unless stated to the contrary, refers to +/−20%, typically +/−10%, typically +/−5%, of the designated value.

As used herein, the term “wearer” refers to any organism that is susceptible to a mosquito attack. For example, the wearer can be an animal, a mammal, a primate, a livestock animal (e.g., sheep, cow, horse, pig), a companion animal (e.g., dog, cat), or a laboratory animal (e.g., mouse, rabbit, rat, guinea pig, hamster). In one example, the wearer is a mammal. In one preferred embodiment, the wearer is human. In one alternative embodiment, the wearer is a non-human animal.

The term, an “effective amount”, as used herein, refers to an amount of a insect repellent effective to achieve a desired effect or improvement without undue adverse side effects. It is understood that “an effective amount” can vary from user to user, due to variation in age, height and/or weight.

Herein “weight %” may be abbreviated to as “wt %”.

The term “mask” or “masking”, as used herein, refers to the perception that insect detection may be diminished when a wearer of an wearable insect repellent patch is in close proximity to an insect. It will be appreciated that the term is not intended to prevent insect detection or completely mask the wearer from insect detection.

The term “essential oil”, as used herein, refers to a concentrated hydrophobic liquid containing volatile (can be evaporated at atmospheric and room temperature) chemical compounds derived from plants, for example. An essential oil, as used herein, is “essential” in the sense that it contains the “essence of” a plant's fragrance, i.e. the characteristic fragrance of the plant from which it is derived. In other words, the term “essential” used herein does not mean indispensable or usable by the human body, as with the terms “essential amino acid”, for example, which are so called because they are nutritionally required by a given living organism.

### Insect Repellent Patch

The inventors have surprisingly found that a wearable insect repellent patch comprising an all-natural insect repellent can repel insects and/or mask a wearer from insect detection. The wearable patch consists of a patch substrate and an adhesive layer on the patch substrate. Advantageously, the combination of the patch substrate comprising or consisting of an insect repellent, and the adhesive layer configured to allow the wearable patch to be removably attached to a wearer, can effectively repel insects and/or mask a wearer from insect detection without diminishing the efficacy or causing discoloration of the adhesive.

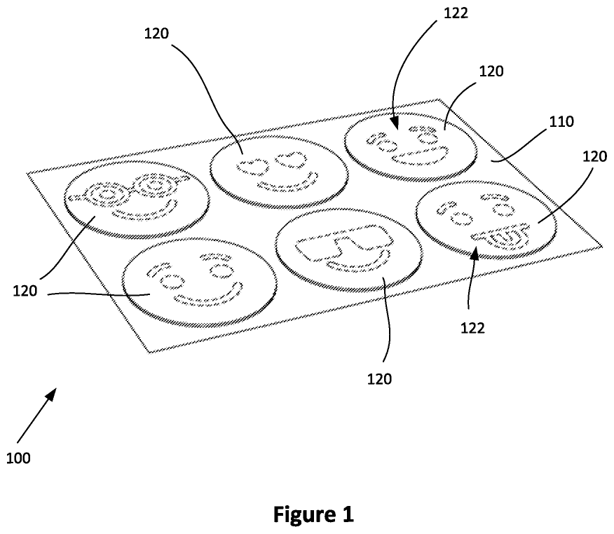

FIG. 1 is a perspective view of a sheet of patches 100 comprising 6 insect repellent patches 120 on a carrier sheet 110 according to some embodiments. The patches 120 may also be provided with a graphic image 122 on the outer face of the patch, the graphic image may be an emoji.

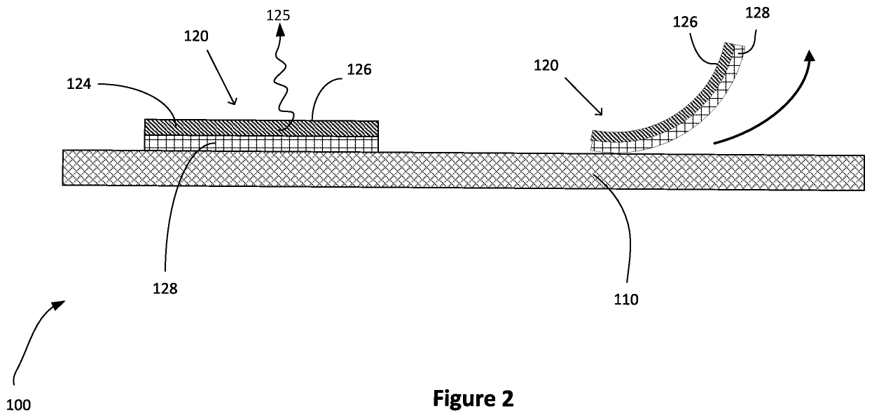

FIG. 2 is a side cross-sectional view of 100 with an insect repellent patch 120 as described herein having an adhesive layer 128 configured to allow the patch to be removed or peeled away from a carrier sheet 110 for application onto a piece of clothing of a wearer. The patch 120 consists of a patch substrate 126 and an adhesive layer 128 on the patch substrate 126. The patch substrate 126 may comprise an active agent 124, wherein the active agent 124 is an insect repellent (e.g. one or more essential oils). The insect repellent consists of one or more essential oils, wherein the vapour pressure of the one or more essential oils at atmospheric pressure and at room temperature may be sufficiently high so that they are partly in the vapour state 125 and released from the patch 120 in an effective amount for repelling insects and/or masking the wearer from insect detection.

The repellent patch 120 may be cut to a predetermined size and shape. The patch 120 may be cut to the predetermined size and shape using digital slitting. For example, the patch 120 may be cut into a rectangular, square, oval, rounded polygon or round shape. In one preferred example, the patch 120 may be a round shape. Each repellent patch 120 may have a diameter (or if non-circular, a largest outer width dimension) in the range of about 1 cm to about 10 cm, for example. In some embodiments, the patch 120 may have a diameter or largest outer width dimension of about 2 cm to about 6 cm, optionally about 3-5 cm, for example. In one preferred example, the repellent patch 120 may have a diameter of about 4 cm.

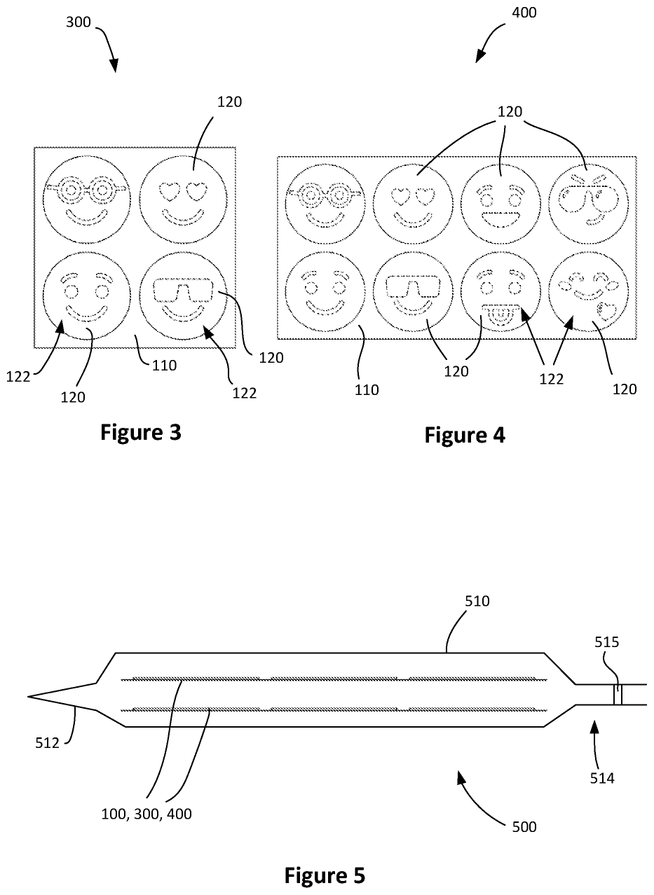

It will be appreciated that variations of FIG. 1 are possible. FIG. 3 is a plan view of a sheet of patches 300 comprising 4 insect repellent patches 120 on a carrier sheet 110 according to some embodiments. FIG. 4 is a plan view of a sheet of patches 400 comprising 8 insect repellent patches 120 on a carrier sheet 110 according to some embodiments. The patches 120 of sheets 300, 400 may also be provided with a colored and/or printed graphic image 122 on the outer face of the patch, and the graphic image may be an emoji, for example.

### Patch Substrate

The patch substrate 126 may be defined by a bottom side (the side attached to the wearer) and a top side (the side exposed to the environment). In some embodiments, the substrate 126 may be non-irritating to the skin of a wearer. In some embodiments, the adhesive substance on the bottom side of the patch is indicated for adhesion to an object or garment associated with a wearer or another human, rather than for direct application a skin of the wearer. The substrate 126 may be a self-supporting sheet of water insoluble, polymeric or natural material that provides strength and integrity for an insect repellent. The substrate 126 of the patch 120 may be vapour permeable. The substrate 126 may also be porous. The porosity may provide openings for receiving the insect repellent 124 and may help assure that the insect repellent patch 120 is vapour permeable. It will be appreciated that the substrate 126 will be porous to the extent that the substrate 126 can retain the insect repellent 124. For example, the substrate 126 may be oleophilic. In other words, the substrate 126 can absorb and/or retain oils or nonpolar liquids (e.g. insect repellent 124) under atmospheric pressure, which can slowly be released as vapour 125 into an environment immediately around the patch 100.

The patch substrate 126 may have any suitable thickness. It will be appreciated that suitable thickness may allow for a flexible, bendable, pliable, vapour permeable, and/or a stretchable sheet of water insoluble porous material. In an embodiment, the thickness of the patch substrate 126 may in a range between about 0.1 mm to about 3.0 mm, about 0.5 mm to about 2.0 mm, or about 1 mm to about 1.5 mm. The thickness of the patch substrate 126 may be at least about 0.1, 0.5, 1.0, 1.5, 2.0, 2.5, or 3.0 mm, for example. The thickness of the patch substrate 126 may be less than about 3.0, 2.5, 2.0, 1.5, 1.0, 0.5, or 0.2 mm, for example. The thickness of the patch substrate 126 may be in a range provided by any two of these upper and/or lower values, for example between about 0.5 and 3.0 mm.

The patch substrate 126 may be manufactured from any material, provided the suitable material can form a suitable flexible, bendable, pliable, and/or stretchable substrate. The substrate 126 may be a flexible porous sheet of water insoluble material that provides support for the wearable insect repellent patch 120 comprising an insect repellent 124. The substrate 126 may include water insoluble polymeric fibers, a porous film, or any other kind of matrix with spaces within the matrix. In embodiment, the substrate 126 may be a lightweight, porous, pliable sheet composed of a nonwoven fabric of polymeric or natural fibers such as polypropylene, polyethylene, polyester, bamboo, cotton or cellulose fibers.

In some embodiments, the patch substrate 126 may include polypropylene fibers, polyethylene fibers, polyester fibers, polyamide fibers, polyurethane fibers, polyol fibers, natural fibers, bamboo fibers, cotton fibers, copolyester fibers, cellulose acetate fibers, polycellulose fibers, or any mixture thereof.

In an embodiment, the patch substrate 126 may be nonwoven fabric. For example, the patch substrate 126 may be polypropylene meltblown nonwoven fabric. In another example, the patch substrate 126 may be a nonwoven filter paper. In another example, the patch substrate 126 may be a nonwoven felt (synthetic or natural). In another embodiment, the patch substrate 126 may be woven fabric.

### Insect Repellent

In some embodiments, the present disclosure may provide an all-natural insect repellent. In an embodiment, the patch substrate 126 may comprise or consist of an active agent 124. The active agent 124 may be an insect repellent that is configured to release 125 an effective amount of the insect repellent for repelling insects and/or masking the wearer from insect detection. The inventors have found that a wearable insect repellent patch 120 consisting of a patch substrate 126 and an adhesive layer 128 on the patch substrate 126, wherein the adhesive layer 128 is configured to allow the wearable patch 120 to be removably attached to a wearer, wherein the patch substrate 126 comprises or consists of an insect repellent that is configured to release 125 an effective amount of the insect repellent, and wherein the insect repellent comprises one or more essential oils, can repel insects and/or mask the wearer from insect detection and avoid disadvantages such as efficacy and discoloration of the adhesive.

### Essential Oils

Essential oils typically include a mixture of one or more terpenes, esters, aldehydes, ketones, alcohols, phenols, and/or oxides. These functional classes of compounds are responsible for the therapeutic properties and distinct fragrance of the essential oil.

In an embodiment, the essential oil may be selected from one or more of the following: ajowan, sweet almond oil, allspice, aloe vera oil, ammi visnaga (khella), amyris, angelica root, angelica seed, anise, anise seed, star anise, apricot kernel oil, absolute arnica, avocado oil, unrefined avocado oil, Copaiba balsam, balsam Peru genuine, balsam Peru oil, balsam peru liquid resin, balsam tolu, sweet french basil, basil, basil ct. methyl chavicol, lemon ct. citral basil, sweet ct. linalool basil, bay laurel, bay leaf, bay rum, bay leaf West Indies, bees wax, unrefined bees wax, benzoin absolute, benzoin resinoid, bergamot, mint bergamot, Italian bergamot oil, free bergaptene bergamot, birch, sweet birch, borage oil, boronia, butter, buchu leaf, cajeput, calamus, calendula oil, infused calendula oil, camellia oil, cannabis, caraway, caraway seed, cardamom, absolute carnation, carrot seed, high carotol carrot seed, carrot seed oil, cassia, cassis bud (black currant), castor oil, catnip, oil of catnip, cedar leaf, western red cedar leaf, cedarwood, Atlas cedarwood, Himalayan cedarwood, Virginia cedarwood, celery seed, chamomile, blue chamomile, German chamomile, Moroccan chamomile, Moroccan wild chamomile, Roman chamomile, champaca, cilantro, cinene, true cinnamon bark, cinnamon bark, cinnamon leaf, cinnamon cassia, cinnamon oil, cistus, citronella, Java citronella, citrus peel oil, ciste oil, artificial civet, clary sage, high sclareol clary sage, clementine, Italian clementine peel oil, clove, clove bud, clove leaf, cocoa, cocoa butter, unrefined cocoa butter, coconut oil, refined coconut oil, cognac, combava petitgrain, coriander, green coriander, corn oil, commint, costus oil, cottonseed oil, cumin, cypress, davana oil, dill, dill weed, eugenol, elemi, erigeron (fleabane), eucalyptus citriodora, eucalyptus globulus, lemon eucalyptus, fennel, sweet fennel, fenugreek, fir, Canada fir needle, Siberia fir needle, white fir needle, frankincense, India frankincense, Oman frankincense, galbanum oil, garlic, genet, geraniol, geranium, geranium leaf, geranium rose, Bourbon geranium, Egyptian geranium, ginger, Cochin extra ginger, ginsing, Siberian ginsing, Korean ginsing, grapefruit, pink grapefruit, white grapefruit, grapeseed oil, hazelnut oil, helichrysum, helichrysum immortelle, Mad. helichrysum, Balkan helichrysum, Corsica helichrysum, France helichrysum, hemp oil, absolute honeysuckle, hyssop, hyssop decumbens, absolute immortelle, fragrant aster inula, Jamaican gold, unrefined Jamaican gold, jasmine, absolute jasmine, grandiflorum jasmine, sambac jasmine, jojoba oil, helio-carrot in jojoba, melissa in jojoba, absolute jonquille, juniper berry, Siberia juniper berry, Croatia juniper berry, lanolin, unrefined anhydrous lanolin, lantana camara, laurel nobilis, lavandin, abrialis lavandin, grosso lavandin, lavender, Oregon lavender, Bulgarian lavender, Russian lavender, high-altitude lavender, wild-crafted lavender, lavendin, organic lavindin, lemon, lemongrass, lime, distilled lime, expressed lime, limonene, linseed oil, litsea, litsea cubeba, blue, pink and white lotus, macadamia oil, mace, green mandarin, red mandarin, yellow mandarin, manuka, absolute marigold, marigold flower, marjoram, Spanish marjoram, sweet marjoram (true), massoia bark, melissa, codistilled melissa, “rectified” melissa, true melissa, absolute mimosa, mimosa, monarda, mugwort, musk seed, myrrh, myrtle, absolute narcissus, neroli (orange blossom), niaouli, nutmeg, extra nutmeg, oakmoss, absolute oak moss, olibanum, absolute opopanax, bitter orange, blood orange, sweet orange, wild West Indian orange, oregano, orris root, concrete orris, osmanthus, palm oil, refined palm oil, palmarosa, paprika, parsley seed, patchouli, Indian patchouli oil, Indonesian patchouli oil, peanut, peanut oil, pecan oil, pennyroyal, pepper, black pepper, super black pepper, peppermint, India peppermint, baby mint peppermint, pet perfume, petitgrain (orange leaves), white pine, pine needle, evening primrose, ravensara anisata, true ravensara, ravensare, ravintsara, redberry, rosalina, rose, rose geranium, rose otto, Bulgarian rose, English rose, Turkish rose, rosehip seed oil, rosemary, rosemary anti-oxidant extract powder, rosemary verbenone, Morocco rosemary, Spain rosemary, rosewood, rosewood oil, rue, sage, white sage, sage dalmatian, sage officinalis, sage triloba, sandalwood, seabuckthorn berry, sesame oil, sesame seed oil, shea butter, unrefined shea butter, soybean oil, spearmint oil, spikenard, green spikenard, spruce, St. John's wort, styrax resin, tagetes, tangerine, Dancy tangerine, tarragon, tea tree, Australia tea tree, thuja (cedar leaf), thyme, red thyme, thyme ct. linalool, thyme vulgaris, wild thyme, red thyme, mixed tocopherols, tolu balsam resin, absolute tuberose, tuberose, tumeric, valerian, vanilla, pure vanilla extract, vanilla bean, absolute vanilla bourbon, vegetable glycerin, absolute verbena, vetiver, violete leaves, vitex, organic Haiti vetiver, absolute violet leaf, walnut oil, wintergreen, natural winter- green, wormwood, yarrow, ylang ylang, ylang ylang I, ylang ylang II, ylang ylang III, ylang ylang compound, ylang ylang complete, and ylang ylang extra.

In an embodiment, the essential oil may be selected from one or more of: citronella oil, lemon eucalyptus oil, eucalyptus oil, tea tree oil, lemongrass oil, geranium oil, lavender oil and lemon oil.

In some embodiments, the amount of citronella oil present in the insect repellent may be between about 40 wt. % to about 80 wt. %. For example, the amount of citronella oil present in the insect repellent 124 may be between about 50 wt. % to about 70 wt. % by weight of the patch substrate 126. The amount (wt. %) of citronella oil present in the insect repellent 124 may be less than about 80, 75, 70, 65, 60, 55, 50, 45, or 40. The amount (wt. %) of citronella oil present in the insect repellent 124 may be at least about 40, 45, 50, 55, 60, 65, 70, 75, or 80. The amount (wt. %) of citronella oil present in the insect repellent 124 may be in a range provided by any two of these upper and/or lower values.

In some embodiments, the amount of lemon eucalyptus oil present in the insect repellent may be between about 1 wt. % to about 40 wt. %. For example, the amount of lemon eucalyptus oil present in the insect repellent 124 may be between about 5 wt. % to about 20 wt. % by weight of the patch substrate 126. The amount (wt. %) of lemon eucalyptus oil present in the insect repellent 124 may be less than about 40, 35, 30, 25, 20, 15, 10, 5, or 1. The amount (wt. %) of lemon eucalyptus oil present in the insect repellent 124 may be at least about 1, 5, 10, 15, 20, 25, 30, 35, or 40. The amount (wt. %) of lemon eucalyptus oil present in the insect repellent 124 may be in a range provided by any two of these upper and/or lower values.

In some embodiments, the amount of eucalyptus oil present in the insect repellent 124 may be between about 1 wt. % to about 40 wt. %. For example, the amount of eucalyptus oil present in the insect repellent 124 may be between about 5 wt. % to about 20 wt. % by weight of the patch substrate 126. The amount (wt. %) of eucalyptus oil present in the insect repellent 124 may be less than about 40, 35, 30, 25, 20, 15, 10, 5, or 1. The amount (wt. %) of eucalyptus oil present in the insect repellent 124 may be at least about 1, 5, 10, 15, 20, 25, 30, 35, or 40. The amount (wt. %) of eucalyptus oil present in the insect repellent 124 may be in a range provided by any two of these upper and/or lower values.

In some embodiments, the amount of tea tree oil present in the insect repellent 124 may be between about 1 wt. % to about 40 wt. %. For example, the amount of tea tree oil present in the insect repellent 124 may be between about 1 wt. % to about 15 wt. % by weight of the patch substrate 126. The amount (wt. %) of tea tree oil present in the insect repellent may be less than about 40, 35, 30, 25, 20, 15, 10, 5, or 1. The amount (wt. %) of tea tree oil present in the insect repellent 124 may be at least about 1, 5, 10, 15, 20, 25, 30, 35, or 40. The amount (wt. %) of tea tree oil present in the insect repellent 124 may be in a range provided by any two of these upper and/or lower values.

In some embodiments, the amount of lemongrass oil present in the insect repellent 124 may be between about 1 wt. % to about 40 wt. %. For example, the amount of lemongrass oil present in the insect repellent 124 may be between about 1 wt. % to about 15 wt. % by weight of the patch substrate 126. The amount (wt. %) of lemongrass oil present in the insect repellent 124 may be less than about 40, 35, 30, 25, 20, 15, 10, 5, or 1. The amount (wt. %) of lemongrass oil present in the insect repellent 124 may be at least about 1, 5, 10, 15, 20, 25, 30, 35, or 40. The amount (wt. %) of lemongrass oil present in the insect repellent 124 may be in a range provided by any two of these upper and/or lower values.

In some embodiments, the amount of geranium oil present in the insect repellent 124 may be between about 1 wt. % to about 40 wt. %. For example, the amount of geranium oil present in the insect repellent 124 may be between about 1 wt. % to about 15 wt. % by weight of the patch substrate 126. The amount (wt. %) of geranium oil present in the insect repellent may be less than about 40, 35, 30, 25, 20, 15, 10, 5, or 1. The amount (wt. %) of geranium oil present in the insect repellent 124 may be at least about 1, 5, 10, 15, 20, 25, 30, 35, or 40. The amount (wt. %) of geranium oil present in the insect repellent 124 may be in a range provided by any two of these upper and/or lower values.

In some embodiments, the amount of lemon oil present in the insect repellent 124 may be between about 1 wt. % to about 40 wt. %. For example, the amount of lemon oil present in the insect repellent 124 may be between about 1 wt. % to about 15 wt. % by weight of the patch substrate 126. The amount (wt. %) of lemon oil present in the insect repellent 124 may be less than about 40, 35, 30, 25, 20, 15, 10, 5, or 1. The amount (wt. %) of lemon oil present in the insect repellent 124 may be at least about 1, 5, 10, 15, 20, 25, 30, 35, or 40. The amount (wt. %) of lemon oil present in the insect repellent 124 may be in a range provided by any two of these upper and/or lower values.

In some embodiments, the amount of lavender oil present in the insect repellent 124 may be between about 1 wt. % to about 40 wt. %. For example, the amount of lavender oil present in the insect repellent 124 may be between about 1 wt. % to about 15 wt. % by weight of the patch substrate 126. The amount (wt. %) of lavender oil present in the insect repellent 124 may be less than about 40, 35, 30, 25, 20, 15, 10, 5, or 1. The amount (wt. %) of lavender oil present in the insect repellent 124 may be at least about 1, 5, 10, 15, 20, 25, 30, 35, or 40. The amount (wt. %) of lavender oil present in the insect repellent 124 may be in a range provided by any two of these upper and/or lower values.

The essential oil can be manufactured (i.e., synthesized or partially synthesized). Alternatively, the essential oil can be obtained from a plant or plant component (e.g., plant tissue). Suitable plant or plant components include, e.g., a herb, flower, fruit, seed, bark, stem, root, needle, bulb, berry, rhizome, rootstock, leaf, or a combination thereof.

Any suitable essential oil can be used in the insect repellent 124 provided: (1) the essential oil has the desired properties (e.g., the essential oil effectively repels insects, such as mosquitos, and/or masks a wearer from insect detection); and (2) the essential oil remains stable in an insect repellent patch 120 when stored in a sealed package 500 or container. Preferably, the stability is over a prolonged period of time, e.g., up to about 3 years, up to about 1 year, or up to about 6 months, typically experienced in the manufacturing, packaging, shipping, and/or storage of the wearable insect repellent patch 120. The specific essential oil, or blend thereof, will preferably be non-toxic to mammals (e.g., humans) and will be suitable for the desired use (e.g., attached to an abject or garment associated with the wearer or another human, or applied in a way that allows the essential oils to come into contact with the skin of the wearer or another human). The specific essential oil, including blends thereof, will also preferably comply with any controlling or governing body of law, e.g., EPA, APVMA, FDA and TGA regulations.

The essential oil can be present in any appropriate and suitable amount, provided: (1) the essential oil has the desired properties (e.g., the essential oil effectively repels insects, such as mosquitos, and masks a wearer from insect detection); and (2) the essential oil remains stable in an insect repellent patch 120. Preferably, the stability is over a prolonged period of time, e.g., up to about 3 years, up to about 1 year, or up to about 6 months, typically experienced in the manufacturing, packaging, shipping, and/or storage of the insect repellent patch 120. The specific essential oil, or blend thereof, will preferably be non-toxic to mammals (e.g., humans) and will be suitable for the desired use (e.g., topically). The specific essential oil, including blends thereof, will also preferably comply with any controlling or governing body of law, e.g., FDA and TGA regulations.

In some embodiments, the specific gravity of the insect repellent 124 in the patch substrate 126 may be between about 1% to about 30% by weight of the patch 126 substrate. For example, the specific gravity of the insect repellent 124 in the patch substrate 126 may be between about 5% to about 15% by weight of the patch substrate 126. The specific gravity (wt. %) of the insect repellent 124 in the patch substrate 126 may be less than about 30, 25, 20, 15, 10, 5, or 1. The specific gravity (wt. %) of the insect repellent 124 in the patch substrate 126 may be at least about 1, 5, 10, 15, 20, 25, or 30. The specific gravity (wt. %) of the insect repellent 124 in the patch substrate 126 may be in a range provided by any two of these upper and/or lower values.

### Optional Excipients

In an embodiment, the patch substrate 126 may comprise or consist of an active agent (e.g. insect repellent 124) and optionally one or more excipients. Suitably, the one or more optional excipients may be or include one or more of diluents, solvents, pH buffers, binders, carriers, additives, adjuvants, microemulsions, coarse emulsions, liquid crystals, fillers, emulsifiers, disintegrants, polymers, lubricants, oils, fats, waxes, coatings, viscosity-modifying agents, glidants and the like. In some embodiments, there is provided a wearable insect repellent patch 120 consisting of a patch substrate 126 and an adhesive layer 128 on the patch substrate 126, wherein the adhesive layer 128 is configured to allow the wearable patch 120 to be removably attached to a wearer, wherein the patch substrate 126 consists of an insect repellent 124 that is configured to release 125 an effective amount of the insect repellent 124 for repelling insects and/or masking the wearer from insect detection, and wherein the insect repellent 124 consists of one or more essential oils and optionally one or more excipients.

Diluents may include one or more of microcrystalline cellulose, lactose, mannitol, calcium phosphate, calcium sulfate, kaolin, dry starch, powdered sugar, and the like. Binders may include one or more of povidone, starch, stearic acid, gums, hydroxypropylmethyl cellulose and the like. Disintegrants may include one or more of starch, croscarmellose sodium, crospovidone, sodium starch glycolate and the like. Solvents may include one or more of ethanol, methanol, isopropanol, chloroform, acetone, methylethyl ketone, methylene chloride, water and the like. Lubricants may include one or more of magnesium stearate, zinc stearate, calcium stearate, stearic acid, sodium stearyl fumarate, hydrogenated vegetable oil, glyceryl behenate and the like. A glidant may be one or more of colloidal silicon dioxide, talc or cornstarch and the like. Buffers may include phosphate buffers, borate buffers and carbonate buffers, although without limitation thereto. Fillers may include one or more gels inclusive of gelatin, starch and synthetic polymer gels, although without limitation thereto. Coatings may comprise one or more of film formers, solvents, plasticizers and the like. Suitable film formers may be one or more of hydroxypropyl methyl cellulose, methyl hydroxyethyl cellulose, ethyl cellulose, hydroxypropyl cellulose, povidone, sodium carboxymethyl cellulose, polyethylene glycol, acrylates and the like. Suitable solvents may be one or more of water, ethanol, methanol, isopropanol, chloroform, acetone, methylethyl ketone, methylene chloride and the like. Plasticizers may be one or more of propylene glycol, castor oil, glycerin, polyethylene glycol, polysorbates, and the like.

Reference is made to the Handbook of Pharmaceutical Excipients 9th Edition, Eds. Sheskey, Hancock, Moss & Goldfarb (2020), which provides non-limiting examples of excipients which may be useful according to the present disclosure. Even further, additional excipients and/or additives suitable for use in the wearable insect repellent patches according to the present disclosure are listed in “Inert Ingredients Approved for Use in Minimum Risk Pesticide Products”, at https://www.epa.gov/minimum-risk-pesticides/inert-ingredients-approved-use-minimum-risk-pesticide-products. Other excipients and/or additives suitable for use in the wearable insect repellent patches according to the present disclosure are listed in “Remington: The Science & Practice of Pharmacy”, 23^{rd} Edition, Ed. Adej are (2020), and in the “Prescribers' Digital Reference”, at www._pdr._net (2021, and in “Handbook of Pharmaceutical Excipients”, Third Ed., Ed. A. H. Kibbe, Pharmaceutical Press, 2000.

If present, the content of the one or more excipients may be between about 1% and 30% by weight of the patch substrate 126. For example, the content of the excipient may be between about 5% and 20% by weight of the patch substrate 126. The content (wt. %) of the excipient may be less than about 30, 25, 20, 15, 10, 5, 4, 3, 2, or 1. The content (wt. %) of the excipient may be at least about 1, 2, 3, 4, 5, 10, 15, 20, 25, or 30. The content (wt. %) of the excipient based on the total weight of the patch substrate 126 may be in a range provided by any two of these upper and/or lower values.

Adhesive layer

The insect repellent patch 120 may further comprise an adhesive layer 128. It will be appreciated that any suitable adhesive can be used, provided the adhesive provides the required adhesiveness to the patch substrate 126 and the wearer, without leaving patch residues on the wearer's clothing or other objects (e.g. hats, shoes, strollers, etc) or skin (i.e. without noticeable skin damage/irritation). The repellent patch 120 may be applied to any suitable surface (to which it can adhere) on an object, surface or skin in an area in which it is desired to repel insects and/or mask the presence of humans. The repellent patch 120 may have a local area of effect of around a 0.5, 1, 1.5 or 2 metre radius, for example.

In embodiments, the adhesive may be selected from solvent based adhesives (e.g. polyacrylate, polyvinylpyrrolidone, polyethylene terephthalate, polyisobutylene, and polybutene), water based adhesives, acrylic pressure sensitive adhesives, resin emulsion adhesives (e.g. vinyl acetate resin, acrylic ester copolymer, vinyl acetate/diocyl maleate copolymer, acrylic copolymer, or any combination thereof), silicone based adhesives (e.g. polydimethylsiloxane and resin mixtures), and hot-melt adhesives. Various polymers may be used as the adhesive matrix including cellulose derivatives, chitosan, polyacrylates, polyvinyl acetates, polyesters, polyurethanes, and silicone-based polymers. For example, the adhesive may be an acrylic pressure sensitive adhesive. Regardless of its chemical nature, the adhesive must provide sufficient adhesion, be easily removed from the wearer without leaving any residues on clothing or other objects or skin, and should cause no discernible skin irritation and sensitization during skin contact.

In embodiments, the adhesive may be stable of long periods of time when stored in a sealed (air-tight) package or container. Preferably, the stability is over a prolonged period of time, e.g., up to about 3 years, up to about 1 year, or up to about 6 months, typically experienced in the manufacturing, packaging, shipping, and/or storage of the insect repellent patch 120.

The adhesive layer 128 may have any suitable thickness. It will be appreciated that suitable thickness may allow for a flexible, bendable, pliable, vapour permeable, and/or a stretchable sheet of water insoluble porous material. In an embodiment, the thickness of the patch substrate 126 may in a range between about 0.05 mm to about 3.0 mm, about 0.1 mm to about 2.0 mm, or about 0.5 mm to about 1.5 mm. The thickness of the patch substrate 126 may be at least about 0.05, 0.1, 0.5, 1.0, 1.5, 2.0, 2.5, or 3.0. The thickness of the patch substrate 126 may be less than about 3.0, 2.5, 2.0, 1.5, 1.0, 0.5, 0.1, or 0.05. The thickness of the patch substrate 126 may be in a range provided by any two of these upper and/or lower values, for example between about 0.05 and 1.0 mm.

### Applications

In some embodiments, the present disclosure relates to an insect repellent kit 500, the kit comprising: i) a sealed or sealable package 510, such as a container, pouch or bag formed of plastic or other non-fluid-permeable material; ii) at least one carrier sheet 110 in the package 510, the at least one carrier sheet 110 comprising a plurality of wearable patches 120 configured to be peeled away from the carrier sheet 110, each wearable patch 120 consisting of a patch substrate 126 and an adhesive layer 128 on the patch substrate 126, wherein the adhesive layer 128 is configured to allow the wearable patch 120 to be removably attached to a wearer, wherein the patch substrate 126 comprises an insect repellent 124 that is configured to release 125 an effective amount of the insect repellent 124 for repelling insects and/or masking the wearer from insect detection, and wherein the insect repellent 124 comprises one or more essential oils; and iii) optionally a printed instruction, for example on an outside surface of the package, configured to facilitate use of the wearable patch on the wearer.

In some embodiments, the package 510 may comprise between about 1 and 50 of the carrier sheets. For example, the package 510 may comprise between about 5 and 15 of the carrier sheets 100, 300, 400. The package 510 may comprise less than about 50, 45, 40, 35, 30, 25, 20, 15, 10, or 5 of the carrier sheets 100, 300, 400. The package 510 may comprise at least about 5, 10, 15, 20, 25, 30, 35, 40, 45, or 50 of the carrier sheets 100, 300, 400. The number of carrier sheets 100, 300, 400 in the package 510 may be in a range provided by any two of these upper and/or lower values, e.g. about 10 carrier sheets 100, 300, 400 in the package 510.

In some embodiments, each carrier sheet 110 comprises or carries a single wearable patch 120. In some embodiments, each carrier sheet 110 comprises or carries a plurality of wearable patches 120, i.e. two or more patches of each carrier sheet 110. For example, each carrier sheet may comprise between about 2 and 10 patches. Each carrier sheet may comprise less than about 10, 8, 6, 4, or 2 patches. Each carrier sheet may comprise at least about 2, 4, 6, 8, or 10 patches. The number of patches on each carrier sheet may be in a range provided by any two of these upper and/or lower values, e.g. about 6 patches on each carrier sheet.

In an embodiment, a plurality of the patches 120 may be attached to a carrier sheet 110, wherein the patches 120 are configured to be peeled away from the carrier sheet 110 for application of one or more patches to a wearer. In some embodiments, the carrier sheet 110 may have perforations along at least a portion of the length and/or width of the carrier sheet 110. The perforations in the carrier sheet 110 may be such that the carrier sheet 110 can be torn into smaller sheet portions, wherein each sheet portion may have one or more patches 120 on each portion.

In some embodiments, the thickness of the package 510 may be in a range of between about 1 mm to about 50 mm. For example, the thickness of the package 510 may be between about 5 mm to about 20 mm. The thickness of the package 510 may be less than about 30, 25, 20, 15, 10, 5, or 1 mm. The thickness of the package 510 may be at least about 1, 5, 10, 15, 20, 25, or 30 mm. The thickness of the package510 may be in a range provided by any two of these upper and/or lower values.

In some embodiment, the width of the package 510 may be in a range of between about 5 cm to about 15 cm. The width of the package 510 may be less than about 15, 10, or 5 cm. The width of the package 510 may be at least about 5, 10, or 15 cm. The width of the package 510 may be in a range provided by any two of these upper and/or lower values.

In some embodiments, the length of the package 510 may be in a range of between about 10 cm to about 25 cm. The length of the package 510 may be less than about 25, 20, 15, or 10 cm. The length of the package 510 may be at least about 10, 15, 20 or 25 cm. The length of the package 510 may be in a range provided by any two of these upper and/or lower values.

Consequently, kits 500 can include instructions together with at least one carrier sheet 100, 300, 400, wherein the at least one carrier sheet comprises a single or plurality of wearable patches contained within the sealable or sealed package. Sealing the at least one carrier sheet in the package can be useful to prevent premature loss of the insect repellent into the atmosphere prior to use. As shown in FIG. 5, the package 510 can be sealed on one end 512 and contain an opening at an opposite end 514, the opening being initially sealed at manufacturing and optionally having a manually resealable portion 515. When one or more patches are to be used, the package 510 can be opened by tearing or unsealing one end 514, removing the one or more patches 120 by peeling each off the carrier sheet 110, and attaching by adhesion (by applying light finger-pressure) to a wearer in desired locations. In some embodiments, the package 510 may be made from a flexible non-fluid-permeable plastic which can be sealed. In some embodiments, the present disclosure relates to a method for repelling insects or masking a wearer from insect detection, the method comprising the steps of:

i) providing a wearable insect repellent patch 120 consisting of a patch substrate 126 and an adhesive layer 128 on the patch substrate 126, wherein the adhesive layer 128 is configured to allow the wearable patch 120 to be removably attached to a wearer, wherein the patch substrate 126 comprises an insect repellent 124 that is configured to release 125 an effective amount of the insect repellent 124 for repelling insects an/or masking the wearer from insect detection, and wherein the insect repellent 124 comprises one or more essential oils;

ii) removing one or more patches 120 from a carrier sheet 110 for application onto the wearer; and

iii) applying one or more wearable patches 120 to a wearer for up to 72 hours to repel insects and/or mask the wearer from insect detection.

In some embodiments, the one or more wearable patches 120 may be applied to a wearer for up to 24 hours to repel insects and/or mask the wearer from insect detection. For example, the one or more wearable patches 120 may be applied to a wearer for up to 12 hours to repel insects or mask the wearer from insect detection. In an example, the one or more wearable patches 120 may be applied to a wearer for up to 8 hours to repel insects and/or mask the wearer from insect detection. In a particular example, the one or more wearable patches 120 may be applied to a wearer for up to 6 hours to repel insects and/or mask the wearer from insect detection. In an embodiment, the size of the wearable insect repellent patch 120 may be may be in a range of between about 1 cm to about 8 cm. The length of the size of the wearable insect repellent patch 120 may be less than about 8, 7, 6, 5, 4, 3, 2, or 1 cm. The size of the wearable insect repellent patch 120 may be at least about 1, 2, 3, 4, 5, 6, 7, 8, 9, or 10 cm. The length of the package 510 may be in a range provided by any two of these upper and/or lower values. For example, the size of the wearable insect repellent patch 120 may be about 4 cm.

It will be appreciated that an amount of an insect repellent 124 may be applied to the wearable patch 120 before removing one or more patches 120 from the carrier sheet 110. The one or more wearable patches 120 may then be removed from the carrier sheet 110 for application to a wearer. For example, the method may further comprise saturating the patch substrate with an amount of the insect repellent after step i) but before step iii).

As described herein, an adhesive layer 128 is provided on a patch substrate 126, wherein the adhesive layer 128 is configured to allow the wearable patch 120 to be removably attached to the clothing of a wearer. It will be appreciated that any adhesive can be used for the adhesive layer 128, provided the adhesive provides the required adhesiveness to the patch substrate 126 and the wearer, without leaving patch residues on the wearer's clothing or skin (including skin damage/irritation). The adhesive layer may comprise any adhesive as described herein. In embodiments, the adhesive may be stable of long periods of time. Preferably, the stability is over a prolonged period of time, e.g., up to about 3 years, up to about 1 year, or up to about 6 months, typically experienced in the manufacturing, packaging, shipping, and/or storage of the insect repellent patch 120. The adhesive layer 128 may have any suitable thickness. It will be appreciated that suitable thickness may allow for a flexible, bendable, pliable, vapour permeable, and/or a stretchable sheet of water insoluble porous material.

The patch substrate 126 can be dimensioned to be worn, for example, on an arm or leg of the wearer or an object or garment associated with the wearer or another human. The age and height of the wearer may determine the number of patches 120 required to be worn to provide maximum effectiveness. For wearers between the age of 0 to 2, one patch 120 may be used at any given time and attached to the wearer's clothing in a central location, e.g. chest. For wearers between the age of 3 to 5, two patches 120 may be used at any given time and attached to the wearer's clothing or skin, e.g. one on the arm and one on the leg. For wearers aged of 6+, two to four patches may be used at any given time and attached to the wearer's clothing or skin, e.g. one on each arm and one on each leg.

Assuming that a patch 120 includes an adhesive layer 128 for application onto the clothing of a wearer, the carrier sheet 110 can further be configured to allow the patch 120 to be removed (e.g., peeled off) cleanly for application onto the wearer.

### EXAMPLES

The present disclosure is further described by the following examples. It is to be understood that the following description is for the purpose of describing particular examples only and is not intended to be limiting with respect to the above description.

### Preparation of Insect Repellent Patches

### Example 1

### Preparation of a Citronella Insect Repellent Patch

A first amount of citronella oil was added to a nonwoven fabric and dried. The dried fabric was coloured and printed on the top side, and subsequently saturated with a second amount of citronella oil. Once dried, an adhesive layer was applied to the bottom side of the fabric and dried further. The fabric was cut to the desired shape and size using digital slitting and saturated with a third amount of citronella oil to provide a wearable insect repellent patch.

Six insect repellent patched were removably attached to a carrier sheet and packaged as a kit of 10 sheets in a sealable package.

### Example 2

### Preparation of a Citronella Blend Insect Repellent Patch

A citronella blend of citronella oil (60%), lemon eucalyptus oil (10%), eucalyptus oil (10%), tea tree oil (5%), lemongrass oil (5%), geranium oil (5%), and lemon oil (5%).

A first amount of the citronella blend was added to a nonwoven fabric and dried. The dried fabric was coloured and printed on the top side, and subsequently saturated with a second amount of the citronella blend. Once dried, an adhesive layer was applied to the bottom side of the fabric and dried further. The fabric was cut to the desired shape and size using digital slitting and saturated with a third amount of the citronella blend to provide a wearable insect repellent patch.

Six insect repellent patched were removable attached to a carrier sheet and packaged as a kit of 10 sheets in a sealable package.

1. A wearable insect repellent patch consisting of a patch substrate and an adhesive layer on the patch substrate, wherein the adhesive layer is configured to allow the wearable patch to be removably attached to a wearer or an object associated with the wearer or another human, wherein the patch substrate comprises an active agent, wherein the active agent is an insect repellent that is configured to release an effective amount of the insect repellent for repelling insects or masking the wearer or the object associated with the wearer or another human from insect detection, and wherein the insect repellent consists of one or more essential oils.

2. The patch according to claim 1, wherein the patch substrate includes a woven fabric, wherein only the active agent is present within the woven fabric.

3. The patch according to claim 1, wherein the patch substrate includes a non-woven fabric, wherein only the active agent is present within the non-woven fabric.

4. The patch according to claim 1, wherein the adhesive layer is selected from solvent based adhesives, water based adhesives, acrylic pressure sensitive adhesives, resin emulsion adhesives, silicone based adhesives, and hot-melt adhesives.

5. The patch according to claim 1, wherein a thickness of the patch substrate is in the range of between about 0.1 mm to about 3.0 mm.

6. The patch according to claim 1, wherein a specific gravity of the insect repellent in the patch substrate is between about 1% to about 30% by weight of the patch substrate.

7. The patch according to claim 1, wherein the insect is a mosquito.

8. The patch according to claim 1, wherein the wearer is a human or non-human animal.

9. The patch according to claim 8, wherein the wearer is a human.

10. The patch according to claim 1, wherein the patch is configured to release an effective amount of the insect repellent over a period of time of up to 72 hours to repel insects and/or mask the wearer from insect detection.

11. A sheet of patches comprising one or more wearable insect repellent patches according to claim 1, wherein the patches are located on one side of a carrier sheet, and wherein the patches are configured to be peeled away from the carrier sheet for application of one or more patches onto a wearer or an object associated with the wearer or another human.

12. A wearable insect repellent patch consisting of a patch substrate and an adhesive layer on the patch substrate, wherein the adhesive layer is configured to allow the wearable patch to be removably attached to a wearer or an object associated with the wearer or another human, wherein the patch substrate comprises an active agent and one or more excipients, wherein the active agent consists of an insect repellent that is configured to release an effective amount of the insect repellent for repelling insects and/or masking the wearer or the object associated with the wearer or another human from insect detection, and wherein the insect repellent comprises one or more essential oils.

13. An insect repellent kit, the kit comprising:
i) a sealed or sealable package;
ii) at least one carrier sheet in the package, the at least one carrier sheet comprising a plurality of wearable patches configured to be peeled away from the carrier sheet, each wearable patch consisting of a patch substrate and an adhesive layer on the patch substrate, wherein the adhesive layer is configured to allow the wearable patch to be removably attached to a wearer or an object associated with the wearer or another human, wherein the patch substrate comprises an insect repellent that is configured to release an effective amount of the insect repellent for repelling insects or masking the wearer or the object associated with the wearer or another human from insect detection, and wherein the insect repellent comprises one or more essential oils; and
iii) a printed instruction configured to facilitate use of the wearable patch on the wearer or the object associated with the wearer or another human.

14. The kit according to claim 13, wherein the package comprises between about 1 and 50 of the carrier sheets.

15. The kit according to claim 13, wherein a thickness of the package is in a range of between about 1 mm to about 30 mm.

16. The kit according to claim 13, wherein a width of the package is in a range of between about 5 cm to about 15 cm.

17. The kit according to claim 13, wherein a length of the package is in a range of between about 10 cm to about 25 cm.

18. A method for repelling insects or masking a human from insect detection, the method comprising the steps of:
i) providing a wearable insect repellent patch consisting of a patch substrate and an adhesive layer on the patch substrate, wherein the adhesive layer is configured to allow the wearable patch to be removably attached to a wearer or an object associated with the wearer or another human, wherein the patch substrate comprises an insect repellent that is configured to release an effective amount of the insect repellent for repelling insects or masking the wearer or the object associated with the wearer or another human from insect detection, and wherein the insect repellent comprises one or more essential oils;
ii) removing one or more patches from a carrier sheet for application onto the wearer or the object associated with the wearer or another human; and
iii) applying the one or more wearable patches to a wearer or an object associated with the wearer or another human for up to 72 hours to repel insects or mask the wearer or an object associated with the wearer or another human from insect detection.

19. The method according to claim 18, further comprises saturating the patch substrate with an amount of the insect repellent after step i) but before step iii).
